(19) United States
(12) Patent Application Publication
(10) Pub. No.: US 2016/0019570 A1
(43) Pub. Date: Jan. 21, 2016

(54) APPARATUS, METHOD, AND COMPUTER-READABLE RECORDING MEDIUM FOR PROVIDING SURVEY

(71) Applicant: NAVER CORPORATION, Seongnam-si (KR)

(72) Inventors: Hyun Mee CHUNG, Seongnam-si (KR); Sang Chul LEE, Seongnam-si (KR); Sang Hyun LIM, Seongnam-si (KR); Hye Kyung PARK, Seongnam-si (KR)

(21) Appl. No.: 14/798,947

(22) Filed: Jul. 14, 2015

(30) Foreign Application Priority Data
Jul. 16, 2014 (KR) 10-2014-0089894

(51) Int. Cl. G06Q 30/02

(52) U.S. Cl. CPC G06Q 30/0203

(57) ABSTRACT

A method, apparatus, system, and non-transitory computer readable medium of providing a survey includes receiving a search request from a user terminal, displaying a survey corresponding to a search word included in the search request on a region of a search result screen, generating a survey question for the survey according to a user's input using the user terminal, receiving answers to survey questions included in the survey, and providing a result of conducting the survey, which is obtained by analyzing the answers to the survey, to a service server when the survey is ended.

### CROSS-REFERENCE TO RELATED APPLICATION

This application claims the benefit of Korean Patent Application No. 10-2014-0089894, filed on Jul. 16, 2014, in the Korean Intellectual Property Office, the disclosure of which is incorporated herein in its entirety by reference.

### BACKGROUND

1. Field

One or more example embodiments relate to an apparatus, method, and/or computer-readable recording medium for providing a survey, poll, quiz, questionnaire, or the like, and more particularly, to a survey providing apparatus and/or method capable of providing a detailed search result, based on a searcher's answer to a survey, poll, quiz, questionnaire, or the like, and a computer-readable recording medium therefore.

2. Description of the Related Art

Online advertisements should be understood as advertisements provided to users on an area of a web page. A representative example of online advertisements is a banner advertisement in which advertisement contents are displayed through a banner on a web page. However, users are apt to view only information that they are interested in and are thus not likely to view banner advertisements which occupy a great part of online advertisements. In general, an advertiser's bill is estimated based on the number of times that a banner advertisement is clicked. However, the banner advertisement may be clicked by dishonest means and thus the effectiveness thereof is not high.

### SUMMARY

One or more example embodiments are directed towards providing a search result including a survey, poll, quiz, questionnaire, or the like corresponding to a search word input by a user, and providing a search result differently according to the user's answer to the survey, poll, quiz, questionnaire, or the like.

One or more example embodiments are directed to advertising and/or promoting a site while conducting a survey, poll, quiz, questionnaire, or the like by providing images of the specific site as examples of a survey (poll, quiz, questionnaire, or the like) question.

One or more example embodiments are directed to inducing more users to answer a survey, poll, quiz, questionnaire, or the like by providing a reward to the terminals of users who answer survey (poll, quiz, questionnaire, or the like) questions.

Additional aspects will be set forth in part in the description which follows and, in part, will be apparent from the description, or may be learned by practice of the presented example embodiments.

According to one or more example embodiments, an apparatus for providing a survey includes a memory having computer readable instructions stored thereon, and one or more processors configured to execute the computer readable instructions to, receive at least one search word from a user terminal, display at least one survey corresponding to the search word on a region of a search result screen, generate a survey question for the survey according to a user's input using the user terminal, receive answers to survey questions included in the survey, and provide a survey result related to the received answers to a service server when the survey is ended.

The apparatus may provide two or more example answers for each of the survey questions.

The survey may include at least one survey question. The apparatus may provide the at least one survey question in a desired order, and determine at least one additional survey question to provide to the user terminal based on at least one answer received from the user terminal in response to the at least one survey question.

The apparatus may provide received answers and a selected example answer to the service server when one of the at least one example answer to the survey question is selected.

The apparatus may further provide a reward to the user terminal.

The provided reward may be based on the received answers.

The apparatus may provide a reward to the user terminal when a ratio of answered survey questions to all survey questions is equal to or greater than a desired threshold when the survey includes a plurality of survey questions.

The apparatus may further register a survey transmitted by a second user terminal.

The apparatus may further receive a main page from the service server, the main page selected based on the survey result.

According to one or more example embodiments, a method of providing a survey includes receiving, using a processor, a search request from a user terminal, displaying, using the processor, at least one survey corresponding to a search word included in the search request on a region of a search result screen, generating, using the processor, at least one survey question for the at least one survey according to a user's input using the user terminal, receiving, using the processor, answers to the at least one survey question included in the at least one survey, and providing, using the processor, a survey result related to the received answers to the at least one survey to a service server when the survey is ended.

The providing of the at least one survey question may include providing three or more example answers to each of the at least one survey question.

The providing of the at least one survey question may include providing two example answers of each of the survey questions.

The at least one survey may include at least one survey question. The providing of the at least one survey question may include providing the at least one survey question in an order in which the at least one survey question was registered, and providing a next survey questions based on at least one received answer in response to the provided at least one survey question.

The providing of the survey result may include providing the service server with a search result including a selected example answer and the received answers to at least one of the provided at least one survey question when one of the at least one example answer of the at least one survey question is selected.

The method may further include providing, using the processor, a reward to the user terminal.

The providing of the reward may include providing the reward based on the received answers.

The providing of the reward may include providing the reward to the user terminal when a ratio of answered survey questions to all survey questions is equal to or greater than a desired threshold when a plurality of survey questions are included in the survey.

The method may further include receiving a survey registration request from a second user terminal.

The method may further include, receiving a main page from the service server, the main page selected based on the survey result.

According to one or more example embodiments, there is provided a non-transitory computer-readable recording medium including computer-readable instruction that, when executed by one or more processors, controls the one or more processors to perform the method.

According to one or more example embodiments, a system may include a server configured to receive a registration request from at least one first user terminal, the registration request including at least one question and a desired search term the survey is associated with, a second user terminal configured to transmit a search request to the server, the search request including at least one search term, and the server may be configured to, generate a survey based on the at least one question, associate the generated survey with the desired search term, and provide the generated survey to the second user terminal in response to receiving the search request when the at least one search term in the search request is related to the desired search term.

The registration request may include content to be displayed to participants in the registered survey and the server may be further configured to provide the additional content to the second user terminal when the generated survey is provided to the user terminal.

The second user terminal may include a plurality of user terminals, each of the plurality of user terminals configured to transmit a search request to the server, and the server may be further configured to generate a plurality of surveys in response to receiving a plurality of registration requests, and to provide at least one survey of the plurality of surveys to the plurality of second user terminals in response to the search requests.

The registration request may include a desired survey participant characteristic information, and the server may be further configured to determine user profile information of the user of the second user terminal and provide the generated survey to the second user terminal if the determined user profile information corresponds to the desired survey participant characteristic information

According to one or more example embodiments, there are provided other methods, apparatuses, and systems for accomplishing the inventive concepts, and a non-transitory computer-readable recording medium having recorded thereon a computer program for performing the other methods.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a schematic diagram of a survey providing system according to at least one example embodiment;

FIG. 2 is a block diagram of a survey providing apparatus according to at least one example embodiment;

FIG. 3 is a flowchart of a method of providing a survey, according to at least one example embodiment;

FIGS. 4A and 4B illustrate search results with a survey advertisement according to at least one example embodiment;

FIGS. 5A-5C illustrate survey questions provided in multiple choice form according to at least one example embodiment; and

FIGS. 6A-6D illustrate survey questions provided in a tournament according to at least one example embodiment.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

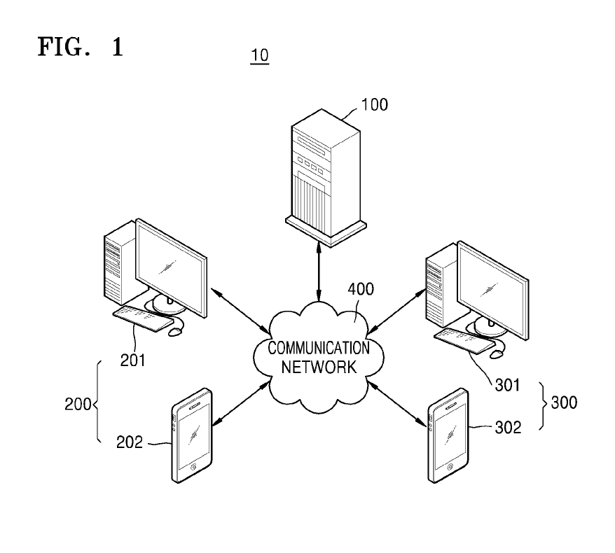

FIG. 1 is a schematic diagram of a survey providing system 10 according to at least one example embodiment.

Referring to FIG. 1, the survey providing system 10 may include a survey providing apparatus 100, a service server 300, and a user terminal 200.

The survey providing system 10 according to an example embodiment may provide the user terminal 200 requesting a search from a search engine, website portal, content website, such as a website containing videos or music, or other website, with not only a search result matching, associated with, and/or related to at least one search word (or, search term) but also a survey, poll, quiz, questionnaire, medical history form, personal history form, employment history form, information request form, data collection form, census, or the like (collectively hereinafter referred to as survey) matching, associated with, and/or related to the search word, and transmit a user's answer to a survey question to the service server 300 so that the service server 300 may provide another main page according to the user's answer. A user who answers the survey may be provided with a reward. The survey matching the search word may be a survey in which a keyword matches a search word input by the user, a popular search word input by a plurality of users, or is included in the search word.

In the survey providing system 10 according to at least one example embodiment, a survey may be registered by the user terminal 200. The survey may include at least one survey question, and may also include at least one example survey question, an example answer to the survey corresponding to the survey question, the sum of rewards, at least one search word (e.g., keyword, etc.), and/or information regarding a related field, etc.

A user may be exposed to a survey question and/or examples registered by a person who registers a survey while answering a survey question provided from the survey providing system 10, by using the user terminal 200. As described above, the survey providing system 10 may provide users with examples of a specific product, content, and/or service to advertise and/or promote the specific product, content, and/or service to the users.

At least one search word input by a user into a search engine, website portal, content website, such as a website containing videos or music, or other website, according to a survey question provided from the survey providing system 10 may be specified. As described above, the survey providing system 10 may provide a survey corresponding to a desired criterion, such as the user's search word, a popular search word, or the like, collect answers to the survey, and provide the answers to the service server 300. Thus, the service server 300 may provide different web pages according to the answers provided by the user to the survey. A user may access the survey providing apparatus 100 via the user terminal 200. The user terminal 200 may be a user's personal computer (PC), smart device, mobile terminal, or the like. The user's mobile terminal may be a smart phone, a tablet, a laptop, a PDA, a smart PC, a smart watch, other wearable device, etc. However, the user's mobile terminal is not limited thereto, and any terminals in which an application has a web browsing function may be employed without limitations.

Although not shown, the user terminal 200 may include a display unit configured to display images, and an input device configured to receive data from a user. The input device may include a keyboard, a mouse, a track ball, a microphone, buttons, a touch panel, etc. but is not limited thereto.

A person who registers a survey may access the survey providing apparatus 100 via the user terminal 200. The person who registers the survey may transmit a request to register the survey via the user terminal 200 to the survey providing apparatus 100. The request to register the survey is a request to provide the survey together with a search result in response to the input of a keyword into a search engine or other website, and may include at least one keyword, at least one survey question, and/or one or more example questions of the survey, one or more example answers to survey question, etc. Also, the request to register the survey may include a request to provide a survey question according to a desired characteristic, setting, requirement, or the like, for example a point of time when a user's search was conducted (e.g., a desired date and/or time), a position at which a search request was input, the user's sex and age, other user demographic information, etc. The person who registers the survey may register the survey to advertise and/or promote his/her web site, his/her content, such as videos, music, art, etc., products to be sold, his/her shop, services, etc. and pay for costs for registering the survey. In an additional example embodiment, at least one person who registers a survey may transmit a request to register the survey to the survey providing apparatus 100. Information regarding the survey registered according to the request may include different survey sources (web site addresses, maps, telephone numbers, etc.), images, video, etc. as survey questions, example survey questions, or example answers to the survey questions. In this case, the at least one person who requests to register the survey may pay for costs that are proportional to the number of times that the examples including the sources are selected (clicked).

The survey providing apparatus 100 may be connected to and/or may be related to or associated with a search engine website, social media website, news website, shopping website, educational website, content providing website, web portal, an Internet Service Provider, mobile device application (e.g., smartphone app, tablet app, etc.), software program, or the like. The survey providing apparatus 100 may transmit and receive information relevant to the survey participants to these other websites, services, service providers, and/or servers, such as web browsing information, demographic information, purchasing history, or the like, in order to determine the user profile and/or user demographic information. The survey providing apparatus 100 may determine the user profile and/or user demographic information, by analyzing user information related to areas such as web browsing information, demographic information, purchasing history, or the like, that is stored on the survey providing apparatus 100, search engine websites, social media websites, news websites, shopping websites, educational websites, content providing websites, web portals, Internet Service Providers, mobile device applications (e.g., smartphone app, tablet app, etc.), software programs, etc., that the survey providing apparatus 100 may have access to. Further, the user may provide such information to the survey providing apparatus 100 through an account registration process, participation in an informational survey, previous participation in surveys provided by the survey providing apparatus 100, or the like.

Once the survey registration request is transmitted to the survey providing apparatus 100, the survey providing apparatus 100 generates a survey corresponding to the information included in the survey registration request for display on a website using the included at least one survey question, at least one keyword, etc., in accordance with the user's desired survey criterion, such as the desired date and time that the survey is to be displayed. The generated survey may be created using HTML, SGML, DHTML, AJAX, XML, Javascript, and/or other like web programming languages. The generated survey may also include video and/or audio content, such as video animations presenting the survey questions, survey answers, example survey questions or answers, search results, and/or content to be promoted by the survey, etc.

The service server 300 is a server that may provide services, such as portal site services, bank services, company services, games services, shopping mall services, social commerce services, etc., to the user terminal 200 on the Internet.

The survey providing apparatus 100, the user terminals 200, and the service server 300 of the survey providing system 10 according to at least one example embodiment may be connected to one another by wired and/or wireless connections, for example, via the Internet, an intranet, a Personal Area Network, a Local Area Network, a Wide Area Network, etc., but are not limited thereto.

A communication network 400 connects the user terminals 200, the service server 300, and the survey providing apparatus 100. That is, the communication network 400 refers to any communication network that provides an access path in which the user terminals 200 access the survey providing apparatus 100 to transmit or receive data to or from the survey providing apparatus 100.

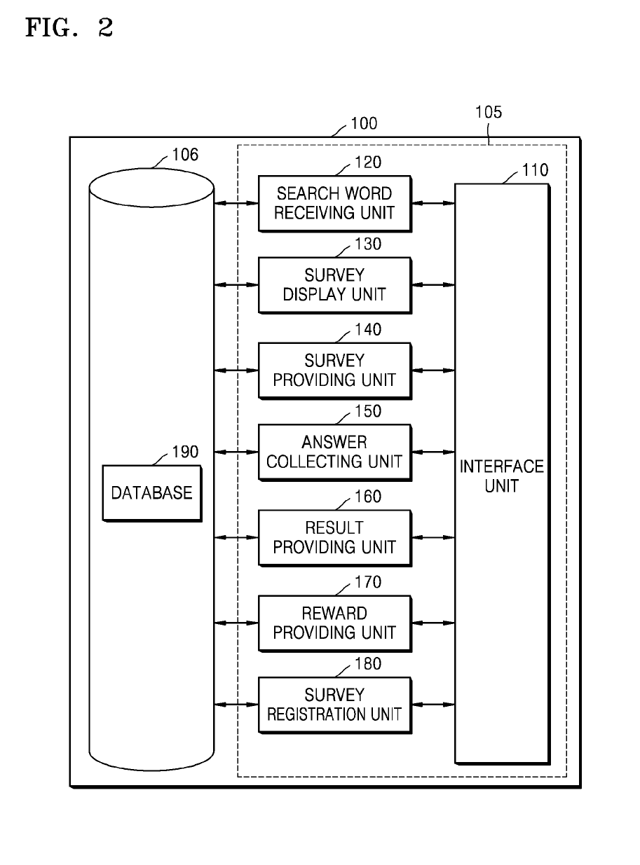

FIG. 2 is a block diagram of a survey providing apparatus 100 according to at least one example embodiment.

Referring to FIG. 2, the survey providing apparatus 100 may include at least one processor 105 and memory 106. The at least one processor 105 (hereinafter referred to in the singular form) may be configured to process computer readable instructions of, for example, a computer program by performing a basic arithmetic and logic operation, and an input/output (I/O) operation of the survey providing apparatus 100, thereby transforming the processor 105 into a special purpose processor. The computer readable instructions may be stored on the memory 106 or other memory. The processor 105 may be configured to execute the computer readable instructions to configure as one or more program modules, such as an interface unit 110, a search word receiving unit 120, a survey display unit 130, a survey providing unit 140, an answer collecting unit 150, a result providing unit 160, a reward providing unit 170, and/or a survey registration unit 180, a database 190, etc. The program modules may be stored at least in part in a storage device such as the memory 106.

The memory 106, as non-transitory computer readable media, may include at least one permanent mass storage device such as random access memory (RAM), read only memory (ROM), a hard drive, a disk drive, and/or the like. Also, a program module for an Operating System may be stored in the memory 106. The software constituent elements may be loaded from non-transitory computer-readable media separate from the memory 106 using a drive mechanism (not shown). The non-transitory computer-readable media may include computer-readable media such as a floppy disk, a tape, a DVD/CD-ROM drive, and/or a memory card. According to other example embodiments, the software constituent elements may be loaded to the memory 106 through the communication network 400, instead of using the non- transitory computer readable media.

The memory 106 may be configured to store program modules for an interface unit 110, a search word receiving unit 120, a survey display unit 130, a survey providing unit 140, an answer collecting unit 150, a result providing unit 160, a reward providing unit 170, a survey registration unit 180, to be executed by the processor 105. The memory 106 may also store a database 190.

The interface unit 110 may provide a communication interface for providing, as packet data, signals exchanged among the survey providing apparatus 100, the user terminals 200, and the service server 300, via the communication network 400.

The search word receiving unit 120 may receive a search word input by a user from the user terminal 200.

The survey display unit 130 may display a survey and a search result related to the search word(s), obtained from a search engine, website portal, content website, such as a website containing videos or music, or other website, on a region of a screen associated with the user terminal 200. The result related to the search word(s) is related to a web site associated with the search word. When a plurality of results are related to the search word(s), the plurality of results may be enumerated in a list displayed on a web page. The plurality of results may be arranged in an order based on degrees to which they match the search word(s) or according to category. For example, a site matching the search word(s) to a larger degree may be first arranged and then a site matching the search word(s) to a smaller degree may be lastly arranged. In relation to the order based on the degrees to which they match the search word(s), the degree to which a result related to the search word(s) obtained at a time point later than a time point when the search was conducted may be determined to be higher than the degrees to which the other results related to the search word(s) match the search word(s) or the degree to which a result related to the search word(s) including at least one keyword included in the search word(s) matches the search word(s) may be determined to be higher than the degrees to which the other results related to the search word(s) match the search word(s). In an additional example embodiment, the survey display unit 130 may first display a site that is set to be first arranged with respect to the search word(s) by a manager of a search system.

The survey display unit 130 may display the keyword and information regarding a survey related to the site, together with information regarding a site including a survey among search results. The survey display unit 130 may also display the title of the survey, a reward to be provided when the survey is completed, etc. Also, the survey display unit 130 may display survey information requested in a site to which the survey is registered to be provided.

For example, if a survey is registered to a site for which a ‘one-piece dress’ is set as a keyword, messages such as “Spring's new arrivals!! 100 points will be accumulated when you select your favorite style” registered in the site may be displayed to persons who search for “one-piece dress” as a search word/search term, together with the site.

In an additional example embodiment, when a search result related to a search word/search term is provided, the survey display unit 130 may display an image, such as an icon, video, etc. to represent that a site includes a survey. The survey display unit 130 may display a search result and survey information on a display panel such as a liquid crystal display (LCD), a light-emitting diode (LED) display, etc.

When receiving a selection input regarding conducting of a survey from a user terminal, the survey providing unit 140 provides information regarding a survey selected to correspond to the selection input. That is, when a user selects a survey, the survey providing unit 140 provides a survey question corresponding to a selected option. Here, the user may select the survey by clicking a mouse, touching a screen, using a motion capture, and/or using voice recognition. The survey providing unit 140 provides survey questions registered by the survey registration unit 180. Each of the survey questions may include one or more example answers. In this case, the provided example answers may include a link to a web page, and the specific page may be related to a product.

For example, the survey providing unit 140 may present example answers, such as ‘casual style’, ‘formal style’, ‘sexy style,’ etc., with respect to a survey question of “What is your favorite one-piece dress style?”, together with images of various products related to the example answers. In this case, the specific products included in the example answers may be exposed to persons who participate in the survey and may thereby entice the person to buy the products.

Also, the survey providing unit 140 may provide a user's terminal that inputs ‘skirt’ as a search word/search term with a survey question related to the search word/search term, such as “What is your favorite skirt style?”. The survey providing unit 140 may present example answers, such as ‘A-line skirt’, ‘long skirt’, ‘miniskirt,’ etc., with respect to the survey question “What is your favorite skirt style?”, together with images thereof. For example, the survey providing unit 140 may provide a user's terminal that inputs ‘one-piece dress’ as a search word/search term with survey information configured to enable a user to select the user's favorite one-piece dress styles. Thus, the user may be able to more concretely select the user's favorite one-piece dress style. The survey providing apparatus 100 may more accurately determine a desired search range among search results corresponding to the search word, based on such answers to survey information, and provide a search result corresponding to the desired search range. Thus, the survey providing apparatus 100 according to at least one example embodiment is capable of more concretely providing a search result according to a survey to a user's terminal requesting a search.

The survey providing unit 140 may provide at least one survey question when one piece of survey information is provided. The survey providing unit 140 may provide at least one survey question in the order in which the at least one survey question has been registered. The survey providing unit 140 may provide a next survey question (hereinafter referred to as a second survey question) differently according to a user's answer to a previous survey question (hereinafter referred to as a first survey question). More specifically, at least one example answer included in the second survey question may be related to or included in a user's answer to the first survey question, i.e., a selected example, or may be a concept subordinate to the user's answer. As described above, the survey providing apparatus 100 according to at least one example embodiment may provide example answers for survey questions while excluding surveys and/or examples that do not match a user's intention. Thus, the survey providing apparatus 100 according to at least one example embodiment may provide contents that meet the user's need. For example, when the user's answer to a survey question “What is your favorite one-piece dress style? is ‘casual style’, the survey providing unit 140 may provide a survey question “What is your favorite length of a one-piece dress among casual style one-piece dresses” as a next question. Also, the survey providing unit 140 may show images of casual one-piece dresses as examples of a survey question. If a user's answer to a survey question “What is your favorite one-piece dress style?” is a formal style, the survey providing unit 140 may provide a next survey question that is different from a survey question provided to a user who selects a casual one-piece dress style. Examples of the next survey question that the survey providing unit 140 provides to a terminal of the user who selects a formal one-piece dress may include images of formal one-piece dresses. Thus, a time required for a user to answer a survey may be reduced, and the survey providing apparatus 100 may rapidly generate a search result matching the user's answer.

As another example, the survey providing unit 140 may present to the user the question, “Are you a Democrat or Republican?”, in response to the user inputting a search term related to politics. Depending on the user's answer, the survey providing unit 140 may present to the user with a poll sponsored by a Democratic candidate, or a Republican candidate, or the like.

The survey providing unit 140 may provide a survey question that makes a search word more concrete, focused, particular, or the like. For example, when a user searches for a one-piece dress, the survey providing unit 140 may sequentially provide questions that make the search word “one-piece dress” concrete, focused, etc., e.g., ‘What is your favorite one-piece dress style?’, ‘What is your favorite color of a one-piece dress?’, ‘What is your favorite size of a one-piece dress?’, ‘What is your favorite length of a one-piece dress?’, etc. The survey providing unit 140 may provide survey questions such that a search range corresponding to the search word is narrowed.

Also, the survey providing unit 140 may provide a survey question registered by a system manager or may generate and provide a survey question based on a search result according to a search word. The generating of the survey question based on the search result according to the search word may be understood as generating and providing a survey question and examples using images, video, and texts included in at least one site, blog, news articles, images, etc. included in the search result according to the search word.

The survey providing unit 140 may provide a survey question in tournament, a multiple choice manner, etc. The tournament refers to a method of selecting one of two examples of the survey question, and the multiple choice manner refers to a method of selecting one of three or more examples of the survey question.

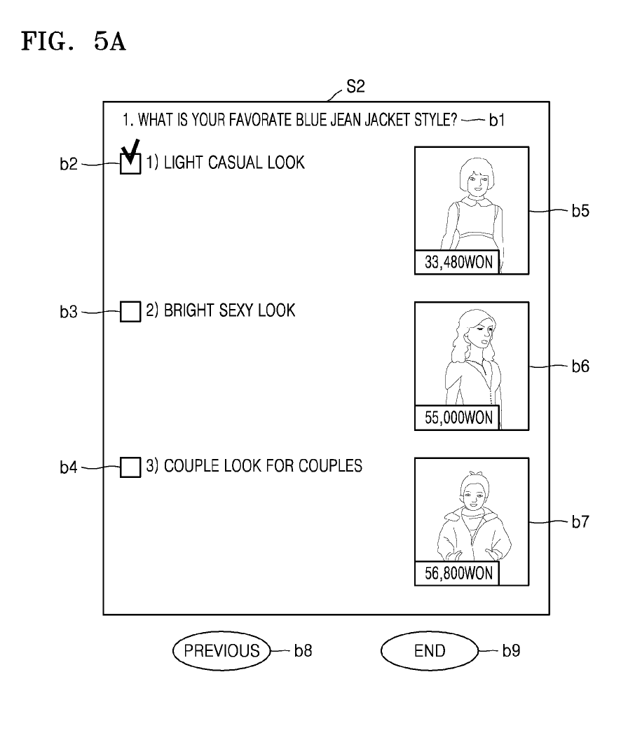

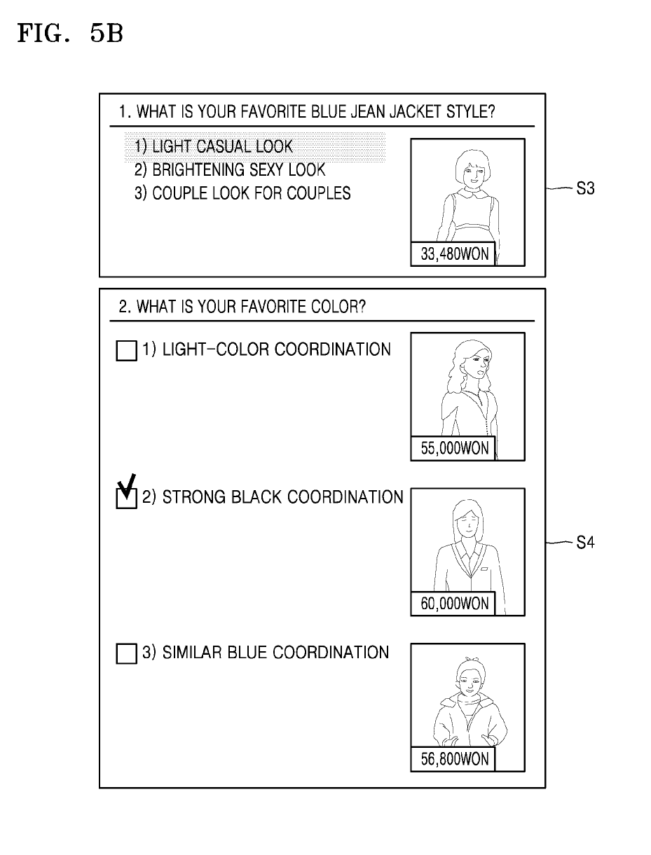

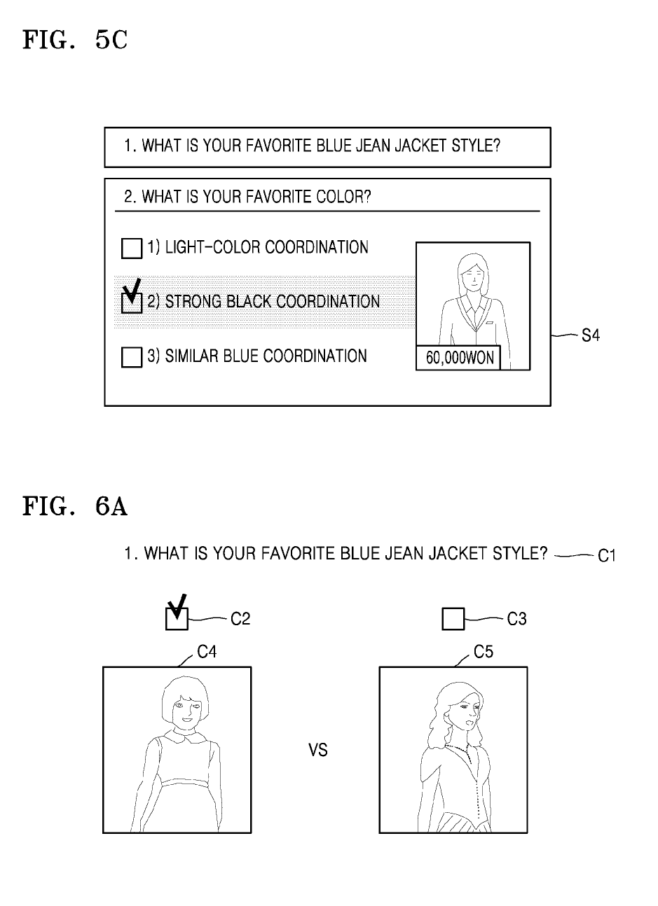

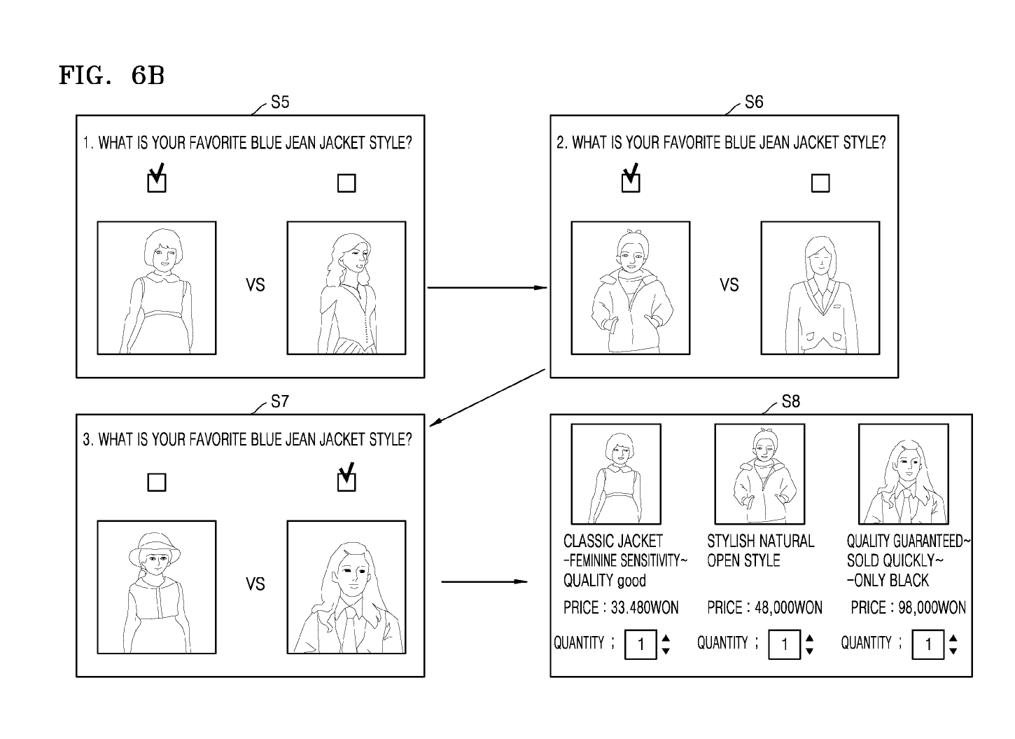

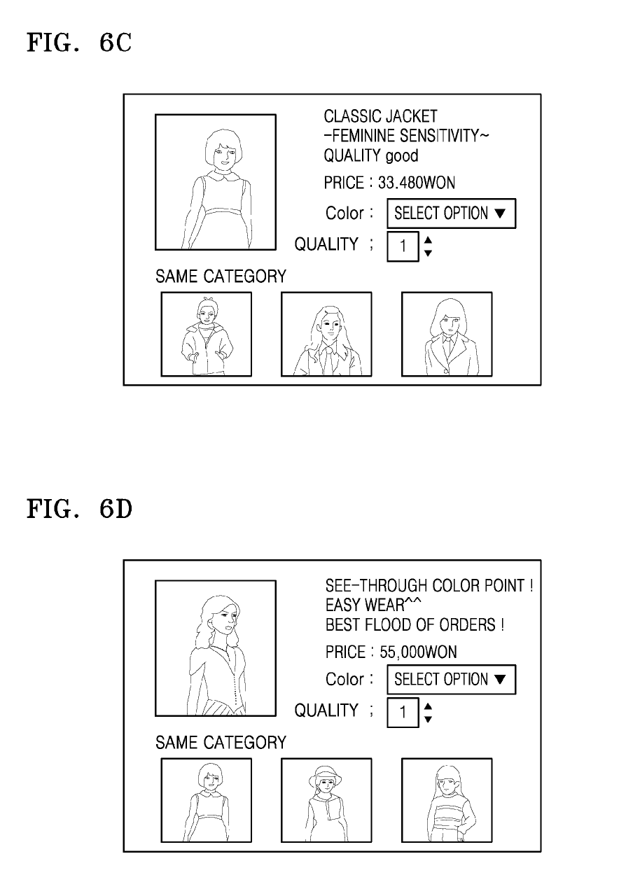

The survey providing unit 140 may provide a survey question in a tournament, as illustrated in FIGS. 6A, 6B, or 6C. In other words, if the survey providing unit 140 provides a survey in a tournament, two example answers are prepared for one survey question and a next survey question is provided when one of the two example answers is selected. Through this process, the survey providing apparatus 100 may finally derive a detailed search word representing a user's search word more concretely and provide a search result according to the detailed search word. Also, the survey providing unit 140 may provide a survey question in a multiple choice manner, as illustrated in FIG. 5A, 5B, or 5C. In other words, if the survey providing unit 140 provides a survey in a multiple choice manner, three or more example answers may be prepared for one survey question and a next survey question is provided when one of the three or more examples is selected. Through this process, the survey providing apparatus 100 according to at least one example embodiment may finally derive a detailed search word that a user desires.

An example of a survey question may include texts, an image, video, and/or a link to a site. Here, the link to the specific site may be a page related to the example answer. For example, in the case of an example answer ‘miniskirt’, a page mainly introducing miniskirts and/or a detailed information page regarding the miniskirt included in the example may be linked to the example ‘miniskirt’. A page introducing resort travel packages and/or a blog regarding resort travels may be linked to an example answer ‘resort travel’. Link pages included in example answers may have been registered by a person who registers a survey, and may be provided when web sites are searched for using examples of a survey question.

The survey providing unit 140 may provide a survey question, example answers of the survey question, signs such as “Previous” and “End”, etc. A previous survey question may be provided again when a user selects “Previous”, and a survey is ended when the user selects “End”.

The answer collecting unit 150 receives at least one answer to a survey question such that the at least one answer matches the survey question, including free-form answers from the user, or in other words, an answer that was not provided by the survey providing unit 140. The answer collecting unit 150 may receive at least one answer to a survey question. The answer collecting unit 150 may receive an answer to a survey question via user input using, for example, a keyboard, a mouse, a touch screen, etc. The answer collecting unit 150 may receive an answer to a previous survey question. The survey providing unit 140 may provide a next survey question differently according to the answer. The answer collecting unit 150 may transmit a received answer to the survey providing unit 140 so that the survey providing unit 140 may use the answer in providing a next survey question. A number of answers to a survey question that the answer collecting unit 150 receives and information regarding the survey question may be provided to the reward providing unit 170 so as to be used to provide a reward to users who answer the survey question.

When a survey is ended, the result providing unit 160 may provide a search result or provide a survey result to the service server 300, according to at least one answer received by the answer collecting unit 150. The result providing unit 160 may provide as a search result a web page including an example answer selected by a user. Also, the service server 300 outside the survey providing apparatus 100 may configure and provide a new main page for users who participate in a survey, based on a survey result provided from the result providing unit 160. The result providing unit 160 may cause the service server 300 according to at least one example embodiment to provide a web page that is first provided (hereinafter referred to as a ‘main page’) and a site map of a searched site differently according to an answer to a survey. When a survey is ended by the result providing unit 160, the service server 300 may provide a web page based on answers received by the answer collecting unit 150. For example, when a user's answer is ‘casual one-piece dress’, the result providing unit 160 may analyze the user's answer, and provide as a search result a page introducing casual one-piece dresses that are miniskirts and have a flower pattern when it is analyzed that the user wants to search for a casual one-piece dress that is a miniskirt and has a flower pattern. As another example, if the user answers that they are a Republican, the result providing unit 160 may analyze the user's answer and provide as a search result a video, a podcast, etc., related to the Republican National Party. As described above, the survey providing apparatus 100 according to an example embodiment may control an external service server that provides a search service according to a survey result to provide a search result (or a link to a web page, content related to or associated with the survey result, or the like) corresponding to a user's answer. Thus, a page matching a user's search intention may be provided to a user terminal that requests a search result to be provided according to a search word while saving effort or time required to select the page.

A survey provided from the survey providing apparatus 100 according to at least one example embodiment may be ended when at least one answer to each of the registered survey questions is received from a user terminal, a desired time to complete the survey has expired, or when an input instructing to select an “End” icon included in a survey question is received.

When a survey is ended, the result providing unit 160 may provide the service server 300 with a survey result matching a user's answer.

Compared to the related art in which a same result is provided for a search word, the survey providing apparatus 100 according to at least one example embodiment may provide a main page of a searched site differently according to a user's answer to a survey, together with a search result according to a search word. Also, even if the survey providing apparatus 100 according to at least one example embodiment controls a service server to provide one site, a main page to be first provided may be provided differently according to a user's answer. As described above, since the survey providing apparatus 100 according to at least one example embodiment provides a search result according to a user's answer to a survey, it is possible to save the user's effort to additionally perform searching and/or move to a desired page, and a page related to an item that the user desires may be rapidly provided to the user.

For example, when it is determined, based on answers to survey questions, that a one-piece dress style requested by a user's terminal is a lively one-piece dress, the survey providing apparatus 100 according to at least one example embodiment may control a page introducing lively one-piece dresses to be finally provided to the user. Also, when it is determined, based on answers to survey questions, that a desired travel requested by a user's terminal is a backpacking travel to Europe for 15 nights and 16 days, the survey providing apparatus 100 according to at least one example embodiment may control a page introducing backpacking travels to Europe for 15 nights and 16 days to be finally provided to the user.

The reward providing unit 170 may provide a reward to a user terminal that answers a survey. The reward providing unit 170 may differently provide a reward to a user terminal that answers a survey. The reward providing unit 170 may differentially provide a reward to a user's terminal which answers a survey, by taking into account the ratio of survey questions that the user answers to all survey questions, or by taking into account the number of survey questions.

For example, a reward given to a user who answers a survey including a total of twenty survey questions may be greater than a reward given to a user who answers a survey including a total of ten survey questions. A reward given to a user who answers all survey questions may be greater than a reward given to a user who does not answer all of the survey questions.

A reward provided by the reward providing unit 170 may be points (mileages) to be used to buy products, a price discount coupon that a user may use to buy a product at a site, a service coupon for using a charged service at a site, etc.

The survey providing apparatus 100 according to an example embodiment may provide a reward to a user who answers a survey and induce more users to select and answer the survey.

In an additional example embodiment, a person who registers survey information may pay for costs for providing a survey using the survey providing apparatus 100.

The database 190 is configured to store the survey information, user information, and search-related information stored in the survey providing apparatus 100.

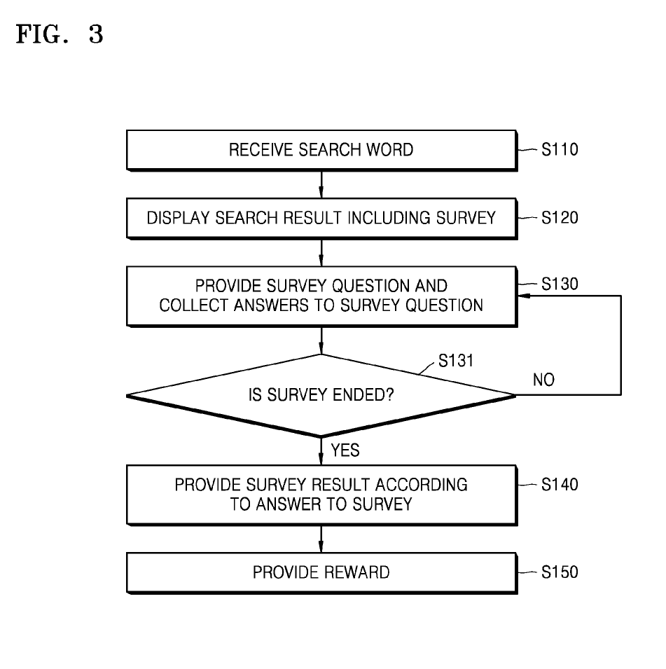

FIG. 3 is a flowchart of a method of providing a survey, according to an example embodiment.

Referring to FIG. 3, the method of providing a survey, according to an example embodiment, may include receiving a search word (operation S110), displaying a search result including a survey (operation S120), providing a survey question and collecting answers to the survey question (operation S130), determining whether the survey is ended (operation S131), providing a survey result according to answers to the survey (operation S140), and providing a reward (operation S150).

In operation S110, an input search word may be received from a user terminal.

In operation S120, a survey may be displayed on a region of a screen, together with a search result according to the search word/search term. The search result may be related to a web site matches, is related to and/or is associated with the search word/search term. When a plurality of search results are obtained, they may be numerated in a list. The plurality of search results may be arranged according to degrees to which they match the search word/search term.

Also, in operation S120, a web site including a survey, which is included in the search result, may be displayed with information regarding the survey. In operation S120, the title of the survey, a reward for the survey, etc. may also be displayed. In operation S120, information regarding the survey that has been registered beforehand may be also displayed.

In operation S130, a survey question is provided and a user's answer to the survey question is received. In operation S130, two example answers, or three or more example answers may be provided for the survey question.

In operation S130, at least one survey question may be provided, and at least one survey question that has been registered beforehand may be provided in a predetermined and/or desired order. A next survey question may be provided differently according to an answer to a previous survey question. Examples of a survey question may include texts, images, video, etc., and particularly, images included in a site to which the survey is registered. Examples of the survey question may include a link to a page. When an image included in an example of the survey question is clicked via a user terminal, the survey may be ended and the specific page may be provided.

In operation S130, a survey question that specifies the search word input by a user may be provided to make the search word more concrete, accurate, focused, particular, etc. In operation S130, a survey question related to the search word may be provided in a tournament, a multiple choice manner, etc. In operation S130, a survey question including two example answers may be provided in a tournament, as illustrated in FIG. 6A, 6B, or 6C. In operation S130, a survey question including three or more examples may be provided in a multiple choice manner, as illustrated in FIG. 5A, 5B, or 5C. In other words, in operation S130, a plurality of example answers may be provided for one survey question and a next survey question may be provided when one of the plurality of example answers is selected. Through this process, a detailed search word matching a user's intention may be derived and a search result for the detailed search word may be provided. In operation S130, a next survey question may be provided by taking into account a user's answer to the survey question.

In operation S130, an answer to the survey question is received. In operation S130, a next survey question may be provided differently according to the received answer (e.g., the next survey question may be dependent upon, or based on, the answer provided to the previous survey question). In operation S130, next survey questions may be provided until the survey is ended. In operation S130, a survey question, example answers to the survey question, and signs “Previous” and “End” (displayed as a text, an icon, an image, etc.) may be provided. The survey is ended when a user selects the sign “End” or when an example image of a survey question is clicked.

In operation S131, it is determined whether the user's participation in the survey is ended. The survey is ended when the user has answered all survey questions, a desired time period for completing the survey has expired, or the user selects the sign “End” to end the survey.

In operation S140, when the user's participation in the survey is ended, a survey result may be provided to a service server, by taking into account the user's answers to the survey. The service server may provide a web page differently according to the user's answers in operation S140.

In operation S150, a reward is provided to a user's terminal that answers the survey. In operation S150, a reward may be differentially provided to the user's terminal that answers the survey. In operation S150, a reward may be differentially provided to the user terminal that answers the survey, by taking into account the ratio of the number of survey questions that the user answers to all survey questions, or by taking into account the total number of survey questions.

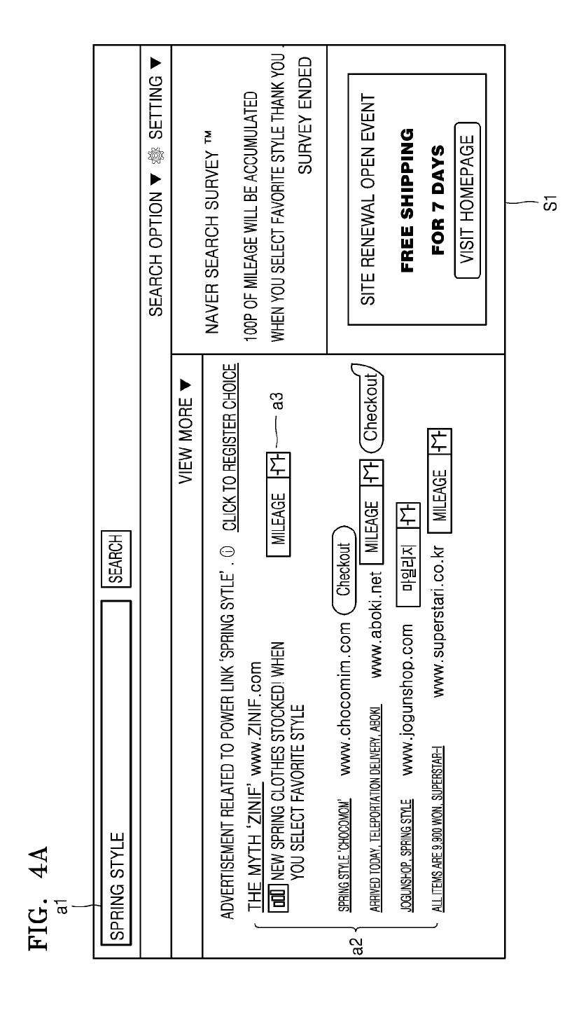

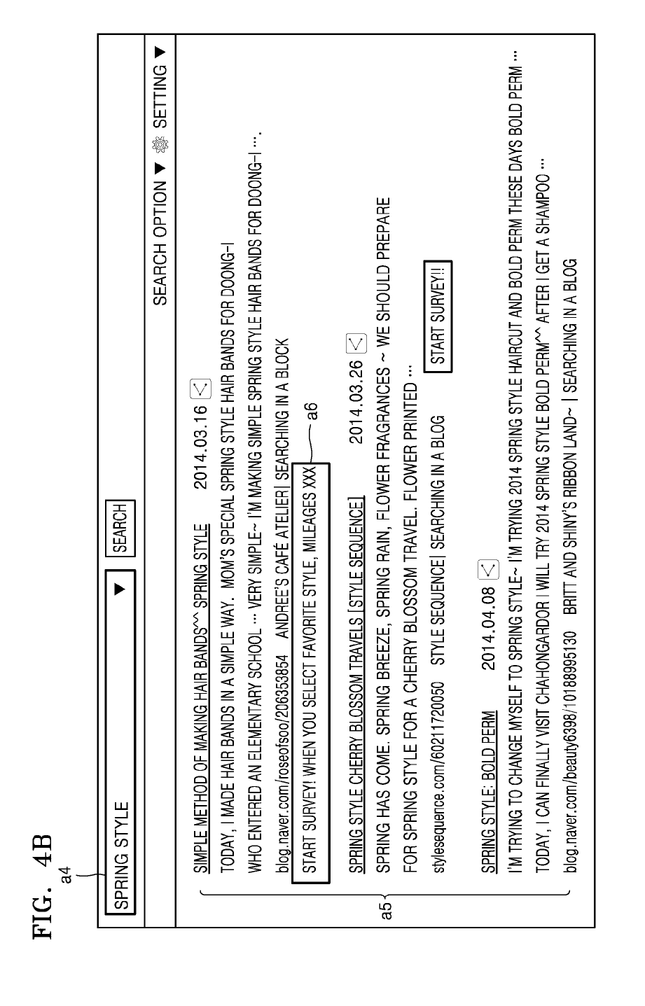

FIGS. 4A-4B illustrate search results with a survey advertisement according to at least one example embodiment.

As illustrated in FIG. 4A, when a user inputs ‘spring style’ as a search word to a search window a1, link advertisements of sites related to ‘spring style’ are displayed on a link advertisement display region a2. According to at least one example embodiment, if an advertiser who files an application for registration of a survey is present among advertisers who registered a link advertisement, an interface providing unit may display survey advertisement information a3 below the link advertisement. That is, when an advertiser of a link advertisement is the same as a person who registers a survey, the survey advertisement information a3 inducing participation in the survey registered by the advertiser may be displayed below the link advertisement, as illustrated in FIG. 4A. A phrase inducing the participation in the survey may include reward information. A user may select this phrase to participate in the survey. As illustrated in FIG. 4B, a site to which a survey is registered among results of performing searching by a user may be displayed together with an icon and/or a phrase for participating in the survey.

A right part of FIG. 4A is a screen displayed when an answerer completes answering a survey. Referring to FIG. 4, a result of providing a reward and an advertisement may be displayed on a survey display region S1. In this case, the advertisement may be an advertisement registered together with the survey by the user terminal 200 that registers the survey.

FIGS. 5A-C illustrate a survey question provided in a multiple choice format according to at least one example embodiment.

A search apparatus and method using a survey according to at least one example embodiment may provide three or more examples b5, b6, b7, etc. for one survey question b1 as illustrated in FIG. 5A. The examples b5, b6, and b7 may include one image, and check box b2, b3, or b4. Also, a screen providing a survey illustrated in FIG. 5 may include an icon b8 for returning to a previous screen and an icon b9 for ending the survey.

Also, in the screen of FIG. 5A, when a user selects a light casual look which is a first example, a next survey question may be displayed with an answer S3 to a first survey question, a second survey question, and examples S4 as illustrated in FIG. 5B. When the second survey question illustrated in FIG. 5B is selected, the screen of FIG. 5A may be switched to a screen S4 of FIG. 5C. Example images illustrated in FIGS. 5A, 5B, and 5C may include price information or products. When one of the example images of FIG. 5a is clicked, a page including the example image may be provided.

FIGS. 6A-6D illustrate a survey question provided in a tournament format according to at least one example embodiment.

A search apparatus and method using a survey according to an example embodiment may provide two examples of one survey question c1 as illustrated in FIG. 6A. The examples may include an image c4 or c5, and a check box c2 or c3 therefor. A screen providing a survey illustrated in FIG. 6 may include an icon for returning to a previous screen and an icon for ending the survey. When a user selects a left part of the screen of FIG. 6A, another survey question and examples may be provided. In FIG. 6A, a page related to a right example or answers to survey questions presented so far as illustrated in FIG. 6C may be linked to the right example, and a page related to a left example or the answers to the survey questions presented so far as illustrated in FIG. 6D may be linked to the left example. As illustrated in FIGS. 6C and 6D, examples may be configured to move to different pages each related to one of the examples. A survey including two examples may be as illustrated in FIG. 6B. When a left example of a first survey is selected (S5), a second survey is moved to. When a left example of the second survey is selected (S6), a third survey may be moved to. When a right example of the third survey is selected (S7), finally, a site may be moved to according to a user's answer (S8).

According to the one or more of the example embodiment, a survey result including a survey corresponding to a search word input by a user may be provided, and a search result that varies according to the user's answer to the survey may be provided.

According to the one or more of the example embodiment, images of sites may be provided as example answers of a survey question so that the specific sites may be advertised while a survey is conducted.

According to the one or more of the example embodiment, a reward is given to a user terminal that answers to a survey question so that more users may be induced to participate in a survey.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, or computer storage medium or device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. An apparatus for providing a survey, the apparatus comprising:
a memory having computer readable instructions stored thereon; and
one or more processors configured to execute the computer readable instructions to,
receive at least one search word from a user terminal;
display at least one survey corresponding to the search word on a region of a search result screen;
generate a survey question for the survey according to a user's input using the user terminal;
receive answers to survey questions included in the survey; and
provide a survey result related to the received answers to a service server when the survey is ended.

2. The apparatus of claim 1, wherein the execution of the computer readable instructions by the one or more processors causes the processor to provide two or more example answers for each of the survey questions.

3. The apparatus of claim 1, wherein the survey comprises at least one survey question, and wherein the execution of the computer readable instructions by the one or more processors causes the processor to,
provide the at least one survey question in a desired order, and
determine at least one additional survey question to provide to the user terminal based on at least one answer received from the user terminal in response to the at least one survey question.

4. The apparatus of claim 1, wherein the execution of the computer readable instructions by the one or more processors causes the processor to,
provide the received answers and a selected example answer to the service server when one of the at least one example answer to the survey question is selected.

5. The apparatus of claim 1, wherein the execution of the computer readable instructions by the one or more processors causes the processor to provide a reward to the user terminal.

6. The apparatus of claim 5, wherein the provided reward is based on the received answers.

7. The apparatus of claim 6, wherein the execution of the computer readable instructions by the one or more processors causes the processor to,
provide a reward to the user terminal when a ratio of answered survey questions to all survey questions is equal to or greater than a desired threshold when the survey includes a plurality of survey questions.

8. The apparatus of claim 1, wherein the execution of the computer readable instructions by the one or more processors causes the processor to register a survey transmitted by a second user terminal.

9. The apparatus of claim 1, wherein the execution of the computer readable instructions by the one or more processors causes the processor to receive a main page from the service server, the main page selected based on the survey result.

10. A method of providing a survey using at least one processor, the method comprising:
receiving, using the processor, a search request from a user terminal;
displaying, using the processor, at least one survey corresponding to a search word included in the search request on a region of a search result screen;
generating, using the processor, at least one survey question for the at least one survey according to a user's input using the user terminal;
receiving, using the processor, answers to the at least one survey question included in the at least one survey; and
providing, using the processor, a survey result related to the received answers to the at least one survey to a service server when the survey is ended.

11. The method of claim 10, wherein the providing of the at least one survey question comprises providing three or more example answers to each of the at least one survey question.

12. The method of claim 10, wherein the providing of the at least one survey question comprises providing two example answers of each of the survey questions.

13. The method of claim 10, wherein the at least one survey comprises at least one survey question, and
the providing of the at least one survey question comprises providing the at least one survey question in an order in which the at least one survey question was registered, and providing a next survey question based on at least one received answer in response to the provided at least one survey question.

14. The method of claim 10, wherein the providing of the survey result comprises providing the service server with a search result including a selected example answer and the received answers to at least one of the provided at least one survey question when one of the at least one example answer of the at least one survey question is selected.

15. The method of claim 10, further comprising providing, using the processor, a reward to the user terminal.

16. The method of claim 15, wherein the reward is based on the received answers to the survey.

17. The method of claim 15, wherein the providing of the reward comprises providing the reward to the user terminal when a ratio of answered survey questions to all survey questions is equal to or greater than a desired threshold when a plurality of survey questions are included in the survey.

18. The method of claim 10, further comprising receiving a survey registration request from a second user terminal.

19. The method of claim 10, further comprising receiving a main page from the service server, the main page selected based on the survey result.

20. A non-transitory computer-readable recording medium including computer-readable instruction that, when executed by one or more processors, controls the one or more processors to perform the method of claim 10.
